(19) United States
(12) Patent Application Publication
(10) Pub. No.: US 2015/0291465 A1
(43) Pub. Date: Oct. 15, 2015

(54) SWIRLING BURNER AND PROCESS FOR SUBMERGED COMBUSTION MELTING

(71) Applicant: CORNING INCORPORATED, Corning, NY (US)

(72) Inventors: Curtis Richard Cowles, Corning, NY (US); Dale Robert Powers, Campbell, NY (US)

(21) Appl. No.: 14/647,347

(22) PCT Filed: Nov. 26, 2013
(86) PCT No.: PCT/US13/71784

§ 371 Date: May 26, 2015

Related U.S. Application Data
(60) Provisional application No. 61/731,857, filed on Nov. 30, 2012.

(51) Int. Cl. C03B 5/235; C03B 5/193; F23D 14/24

(52) U.S. Cl. CPC C03B 5/2353; F23D 14/24; C03B 5/193

(57) ABSTRACT

A swirling burner 100 for submerged combustion melting that swirls at least one of a first gas and a second gas exiting the burner. The burner includes a central tube for delivering the first gas a nozzle and an outer tube for delivering a second gas to the nozzle. Helical vanes or channels are provided in at least one of the central tube and the outer tube to cause a least one of the first gas and the second gas exiting the burner to swirl.

This application claims the benefit of priority to U.S. application Ser. No. 61/731,857 filed on Nov. 30, 2012, the content of which is incorporated herein by reference in its entirety.

### FIELD

This disclosure relates to submerged combustion melting. More specifically, this disclosure relates to burners for submerged combustion melting, and more particularly to swirling burners for submerged combustion melting that generate a swirling flame.

### BACKGROUND

In a conventional glass melter the burners are located above the surface of the glass materials in the melter (e.g. the glass batch materials and later the melted glass materials, or collectively the “glass melt”) and are directed down toward the top surface of glass melt. In an effort to increase the thermal efficiency of glass melters the burners have also been located below the surface of the melt and fire up into the glass melt in what has been referred to as submerged combustion melters (“SCM”s). In a SCM the flame and products of the combustion (primarily carbon dioxide and water) travel through and directly contact the glass melt, thereby transferring heat directly to the glass melt resulting in more efficient heat transfer to the glass melt than in conventional glass melters. More of the energy from the combustion is therefore transferred to the glass melt in an SCM than in a conventional glass melter. The flame and products of the combustion travelling through the glass melt in an SCM also agitate and mix the glass melt, thereby enabling the glass melt to be effectively mixed without the use of mechanical mixers that are typically required in conventional glass melters. The glass melt in a conventional glass melter is not significantly stirred by the presence of the burner and flame above the surface of the glass material without the aid of mechanical mixers. However, use of mechanical mixers in conventional glass melters is problematic. Due to the high temperature and corrosive nature of the glass melt, mechanical mixers in glass melters tend to be expensive and have a short useful life. As a mechanical mixer in a glass melter degrades, material from the mixer contaminates the glass melt. SCM can enable glass melt to be melted and homogenized in a smaller volumes and shorter times than in conventional glass melters employing mechanical mixers. The improved heat transfer and smaller size of an SCM can lower energy consumption and capital costs compared to conventional glass melters.

A prior art SCM burner 10 is illustrated in FIG. 1. The illustrated SCM burner 10 includes two concentric tubes 12 and 14. The center tube 12 delivers natural gas G to a nozzle 18. The outer tube 14 delivers the oxygen O to the burner for combustion of the gas G exiting the nozzle. The outer tube 14 forms part of a cooling jacket 13 that surrounds the inner and outer tubes 12 and 14. The nozzle 18 has a central gas outlet 22 and a plurality of outer gas outlets 24 (for example, as six holes) arranged in a ring around the central gas outlet 22. Passages 25 leading to the outer gas outlets 24 are inclined outwardly from a central axis of the center tube 12 at a gas exit angle A1 of about 5°. Oxygen exits the burner through an annular oxygen outlet 26 formed between the inner surface of the outer tube 14 and the outer surface of the central tube 12. The gas exiting the gas outlets 24 along the gas exit angle Al is directed toward and mixes with the oxygen exiting the oxygen outlet 26 so that the gas combusts generating a flame (not shown) that is fired vertically upward into and through the glass melt (not shown). The prior art burner 10 of FIG. 1 is typically operated with the top of the nozzle 18 and the central tube 12 either flush with top of the outer tube or recessed about 1½ inches below the top of the outer tube 14 (and the top end 28 of the burner) so that the gas can mix with the oxygen before reaching the top end 28 of the burner. Cooling fluid F is circulated through the cooling jacket 13 in order to cool the burner.

The flame travelling vertically though the glass melt in such a SCM from burner 10 as illustrated in FIG. 1 tends to entrain a large amount of the glass melt and spray the glass melt onto the sides the melter (not shown). Some of the entrained glass may even be sprayed into the air exhaust system of the melter. The entrained glass material melt hardens on and coats the upper walls of the melter and the exhaust system, including observation ports, sensor locations, exhaust ducts, etc. The entrained material can also collected in and on the filter system of the pollution abatement system (bag house, filter, etc.), thereby fouling the filters. The combustion products may break through the surface of the glass melt in large “burps” that fling some of the glass melt upwards, which can result in the flinging of unmelted and/or insufficiently mixed glass melt material toward the glass exit of the melter called the tap (not shown). Occasionally some of this unmelted or insufficiently mixed glass melt may exit the tap with the desired fully melted and mixed glass melt, which is very undesirable. The high velocity of the combustion products in a typical SCM burner as illustrated in FIG. 1 can also result in the formation of a large number of gas bubbles in the melt. For many applications it is necessary to remove these gas bubbles in a “fining” stage. During fining, the glass melt must be held at a temperature high enough for the bubbles to rise in the glass melt for removal therefrom, creating a large energy demand. Such a SCM burner may also generate a very loud piercing sound when operated with certain some glass compositions. The noise level can reach about 9- dB or 100 dB creating a major threat to operators' hearing unless both ear plugs and ear muffs are worn.

### SUMMARY

One aspect of the present disclosure facilitates mixing of fuel and oxidizer by a SCM burner is to cause one or both of the oxygen and gas to swirl as it exits the burner. A swirling burner has the advantage that the flame typically bushes or flares out instead of just being focused in the vertical direction of flow. Swirling thus results in enhanced diffusion of the vertical momentum of the combustion gases such that less glass melt is flung by burner inside the SCM, as well as providing enhanced mixing of the combustion gasses.

In one aspect, the present disclosure relates to a burner includes a hollow first central tube having a first longitudinal bore and a second outer tube having a hollow second longitudinal bore. The first tube is disposed within the second tube such that an annular space is defined between the second tube and the first tube. A swirl inducing member is located in the top end of one of the first tube and the annular space for causing a first gas passing through and exiting a top end of the first tube and a second gas passing through and exiting a top end of the second tube (e.g. the annular space) to swirl.

In another aspect of the present disclosure, the burner further includes a nozzle formed at a top end of the second tube. The nozzle may include a plurality of gas outlets formed therein. The gas outlets may be slanted outwardly relative to a longitudinal axis of the nozzle and are in communication with the second longitudinal bore.

In another aspect, the present disclosure relates to a submerged combustion melting apparatus which comprises a melting chamber for containing a molten pool. The melting chamber has an orifice formed in its wall. A burner as described above is positioned at the orifice to inject a flame into the melting chamber.

Other features and advantages of the invention will be apparent from the following description and the appended claims.

One Embodiment Is

A Further Embodiment Includes

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a cross-sectional side view of a Prior Art submerged combustion melter burner;

FIG. 2 is a partial cross-sectional side view of a swirling burner for a submerged combustion melter according to a first embodiment hereof;

FIG. 3 is a partial cross-sectional side view FIG. 2 showing the swirl collar and central tube of FIG. 2;

FIG. 4 is a partial top view of the burner of FIG. 2 showing the central tube, swirl collar and outer tube;

FIG. 5 is a partial cross-sectional side view of a swirling burner for a submerged combustion melter according to a second embodiment hereof;

FIG. 6 is a partial cross-sectional side view of a swirling burner for a submerged combustion melter according to a third embodiment hereof; and

FIG. 7 depicts a submerged combustion melting system including the burner apparatus of FIGS. 2-4.

### DETAILED DESCRIPTION

The invention will now be described in detail with reference to a few embodiments thereof as illustrated in the accompanying drawings. In describing the embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

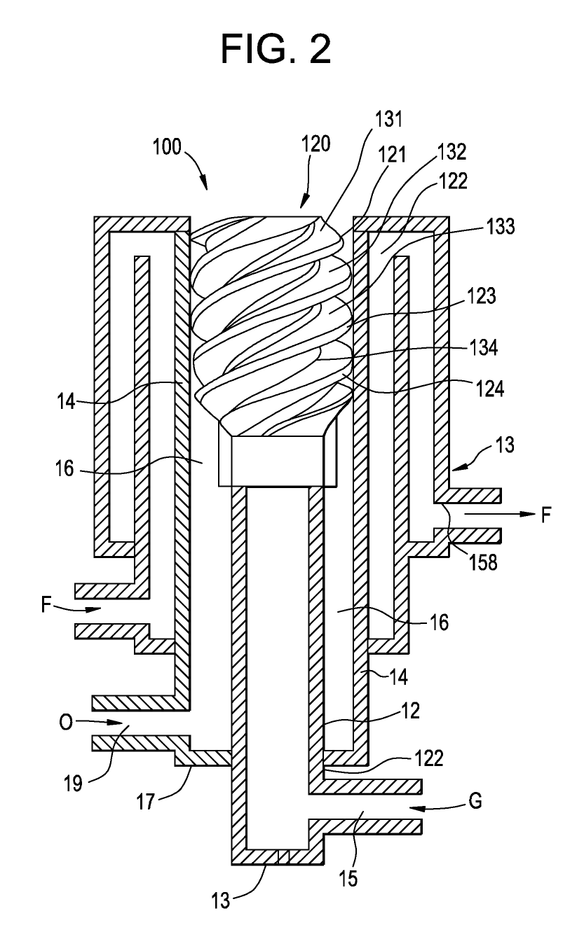

As depicted in FIGS. 2-4, a swirling burner 100 for a SCM according to a first embodiment of the present disclosure includes a hollow first or central tube 12 and a hollow second or outer tube 14, with an annular space 16 defined between the central tube and the outer tube. The central tube may be centered in the outer tube. The central tube 12 may have a closed bottom end 13, which seals the bottom of the central tube. Near the bottom end 13, the inner tube 12 includes a port 15, which is in communication with the interior of the central tube. An external source of gas (not shown), e.g., a source of fuel, can be connected to the port 15 in order to supply gas to the central tube. In other embodiments, the closed bottom end 17 could include a port for introduction of gas into the bore 108. The outer tube 14 has a partially closed bottom end 17 with an opening there through for receiving the inner tube 12. The bottom end 17 seals the bottom of the annular space 16 by extending between the outer tube 14 and the inner tube 12. In the example shown in FIGS. 2, 5 and 6, a bottom portion 13 of the inner tube 12 including the port 15 extends below the bottom end 17 of the outer tube 14. The inner tube 12 may be capable of sliding relative to the opening so that adjustment of the position of the inner tube 12 relative to that of the outer tube 14 is possible. Near the bottom end 17, the outer tube 14 includes a port 19, which is in communication with the annular space 16. An external source of gas (not shown), e.g., a source of oxidant, can be connected to the port 19 in order to supply gas to the annular space 16. Alternatively, the bottom end 17 may include a port for introduction of gas into the annular space 16.

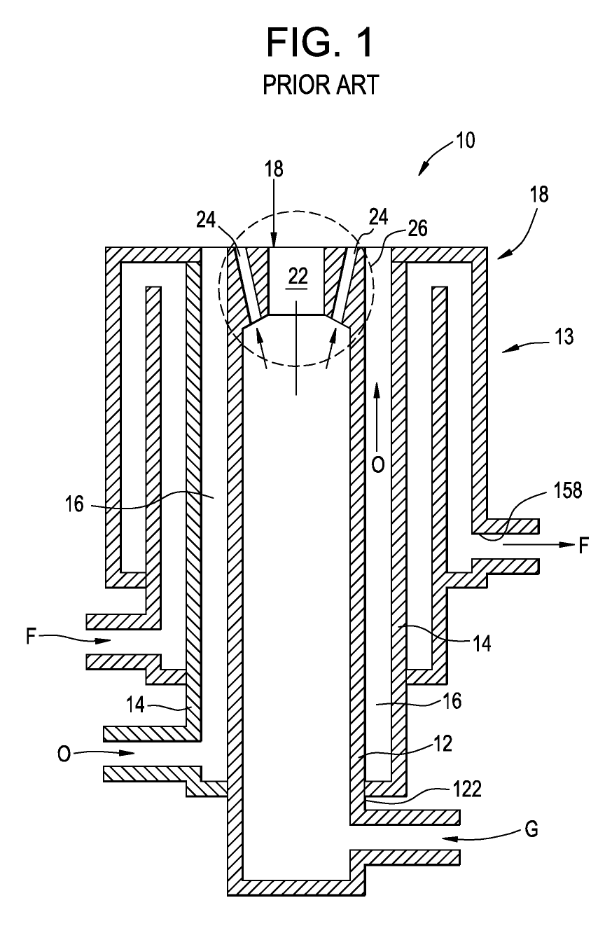

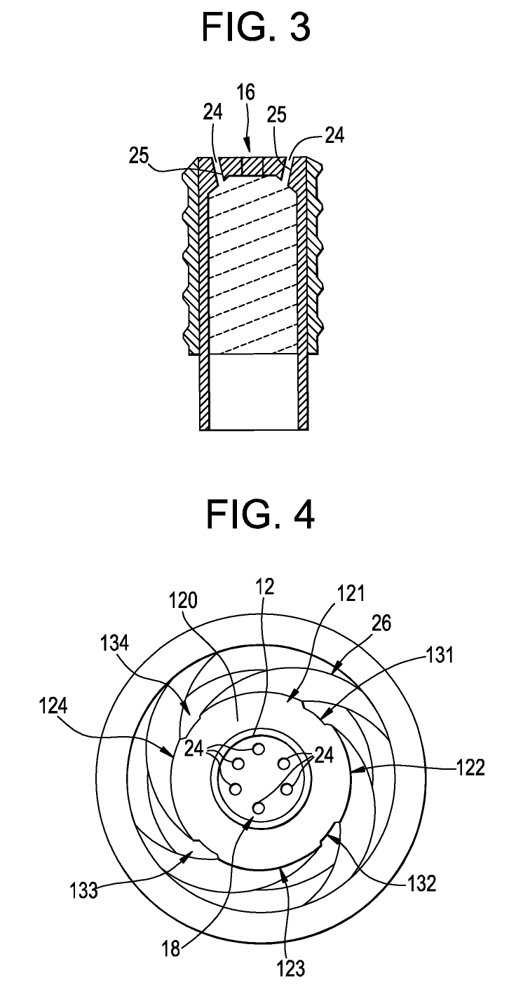

A nozzle 18 may be provided on the top end of the central tube 12. The nozzle may have a plurality of gas outlets holes 24 (for example, six outlets) arranged in a ring around the central axis of the central tube 12. Passages 25 in the nozzle (see FIG. 3) leading to the gas outlets 24 may be inclined outwardly from a central axis of the center tube 12 at an egress angle of about 25°. A swirl collar 120 m mounted inside the outer tube 14 by attaching the swirl collar 120 onto the top end of the central tube 12. Four helical vanes 121, 122, 123, and 124 are formed in the outer peripheral surface of the collar 120 defining four helical channels 131, 132, 133 and 134 in the annular space between the swirl collar 120 and the outer rube 14. The helical vanes and helical channels induce a swirling motion to the oxygen travelling through the outer tube and exiting the SCM burner 100 into the glass melt, thereby causing the oxygen exiting the burner to swirl around the gas exiting the burner. The outer ends of the helical vanes 121, 122, 123 and 124 are either in contact with or close spaced from the inner surface of the outer tube 14 in order to ensure that the oxygen passing through the second tube is swirled by the vanes on the swirling collar. In an alternative embodiment the nozzle may include a central gas outlet, such as gas outlet 22 in FIG. 1. The central outlet may serve as an opening for gas flow or as a receptacle or passage for instruments such as a UV safety sensor.

Referring to FIGS. 2-4, an oxidant (such as oxygen) O is supplied to the annular space 16 through the port 19, and fuel gas G is supplied to the bore 15 through the port 15. The fuel gas exits the inner tube through the nozzle 18 and mixes with the exiting the top of the annular space to form a flame (not shown). As the burner 100 operates, cooling fluid F is supplied to the cooling jacket 13. In submerged combustion melting, the flame of the burner apparatus 100 is formed within the glass melt.

Causing the oxygen to swirl around the gas facilitates mixing of gas and oxygen for more efficient combustion. Swirling flow of oxygen also imparts a lateral component to the velocity of the oxygen exiting from the nozzle 18, which causes the flame created by the burner 100 to expand or flare outward, instead of being primarily focused in the vertical direction as in typical prior art SCM burners as illustrated in FIG. 1. This flaring of the flame causes the momentum of the combustion gases to be more diffused and spread out in the glass melt compared to typical prior art SCM burners, thereby reducing the vertical velocity and momentum of the combustion gases travelling through the glass melt and reducing the flinging of the glass compared to typical SCM burners. A short broad flame can help reduce or eliminate freezing at the point where the flame is injected into the glass melt. This can ultimately help avoid formation of cold finger in the molten pool. To achieve the most swirl of the flame generated by the swirl burner, the gas of the largest volume (and therefore the largest momentum) may be fed through the outer tube 14 and through the helical channels and vanes of the swirl collar. In the illustrated example, oxygen may be supplied at a larger volume than the gas, so oxygen may be supplied through the outer tube and the gas may be supplied through the central tube. However, oxygen may alternative be supplied the central tube and gas may alternatively be supplied to the outer tube.

The illustrated collar 120 has four helical vanes 121-124 arranged 90° from each other forming four helical channels 131-134 arranged 90° from each other as best seen in FIG. 4. However, the number of helical vanes and helical channels may vary. For example, there may be 2 to 6 helical vanes and 2-6 helical channels. Moreover, rather than employing a separate helical collar 120 attached to the central tube 12, the helical vanes 121-124 may alternatively be integrally formed in the outer peripheral surface of the central tube 12 (not shown) forming a single integrally formed component that includes the central tube, the helical vanes, and the nozzle. The illustrated swirl collar 120 is generally cylindrical in form with a smooth cylindrical surface and outwardly extending helical vanes on its outer peripheral surface. Alternatively, the swirl collar may have smooth cylindrical outer peripheral surface that is mounted to the inner surface of the outer tube 14 or inwardly extending helical vanes may be integrally formed on the inner peripheral surface of the outer tube.

The inner tube 12, outer tube 14, nozzle 18, swirl collar 120 and helical vanes 121-124 may be made of any suitable heat-resistant material, such as a stainless steel, e.g. 304, 312, or other high temperature stainless steel, austenitic nickel-chromium-iron alloys, e.g. Inconel®. The angle of the gas outlet passages 25 in the nozzle 18 relative to the longitudinal axis of the central tube may vary from 55°. For example, that egress angle may be in a range of from about 0° to about 75°, from about 15° to about 70°, from about 45° to 50°, from about 25° to about 65°, or about 45° from the central axis of the center tube (e.g. from vertical).

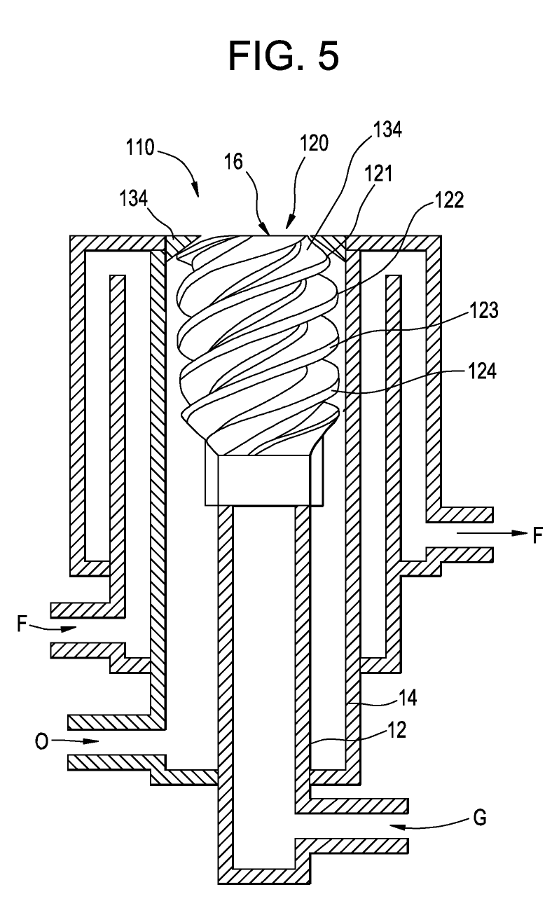

As illustrated in FIG. 5, in an alternative embodiment of the swirl burner 110 of the present disclosure, the inner peripheral surface of the upper portion 144 of the outer tube 14 converges approaching the nozzle 18 such that the swirling oxygen is focused before it is mixed with the gas. The outer ends of the helical vanes 121, 122, 123 and 124 on the upper portion of the swirl collar 120 have a corresponding convergence or taper to maintain the close spacing of the vanes to or contact of the vanes with the inner surface of the outer tube and ensure that the oxygen passing through the second tube is swirled by the vanes on the swirl collar. Focusing the swirling oxygen tends to increase the angular velocity of the oxygen, in the same manner that an ice skater or diver starts to spin with her arms out and then pulls her arms in to accelerate her spin.

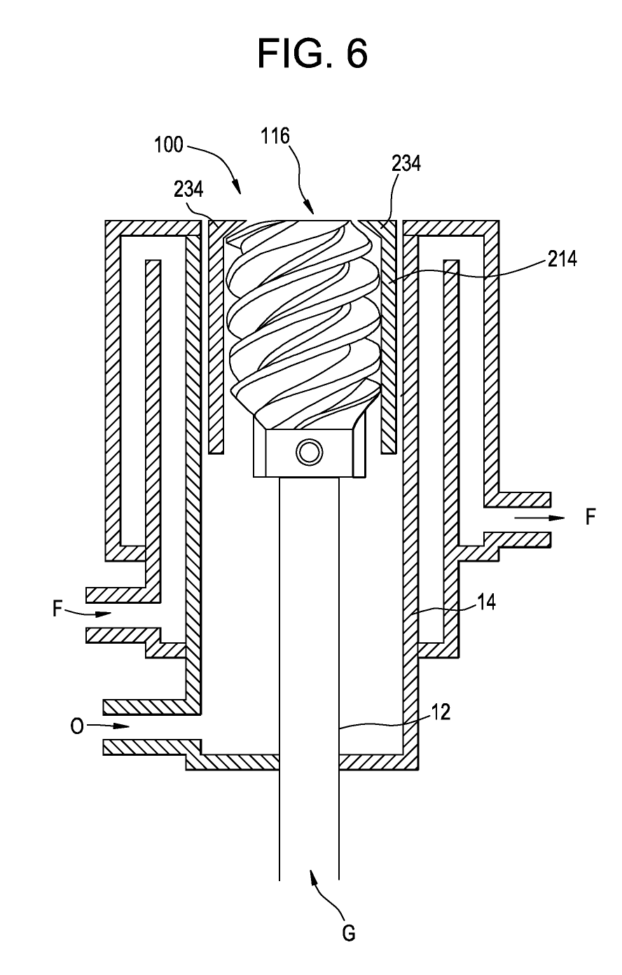

The converging portion 144 may be integrally formed with the outer tube 14. In an alternative embodiment as illustrated in FIG. 6, a cylindrical shroud 214 having an upper converging frustoconical portion 234 may be mounted in the upper end of the outer tube 14. In place of the shroud, a converging ring that comprises just the converging top portion of the shroud 214 in FIG. 6 may be mounted in the upper end of the outer tube (not illustrated).

In an alternative aspect of the present disclosure (not illustrated) both the oxygen and the gas may be swirled. In a first embodiment of this alternative aspect, the oxygen is swirled as it exits the outer tube by a helical vanes and helical channels as previously described herein and illustrated in FIGS. 2-5. A second set of helical vanes and helical channels may be mounted inside the top portion of the central tube in place of the nozzle 18 illustrated in FIGS. 2-5. In this way the gas exiting the central tube is swirled by the second set of helical vanes and helical channels (not illustrated) and the oxygen exiting the outer tube is swirled as previously described herein.

In a third embodiment of this alternative aspect of the present disclosure in which both gases are swirled, rather than add a second swirl collar inside the central tube to swirl the gas, the gas outlet passages in the nozzle may be inclined relative to the vertical in both a direction away from the central axis of the central tube and in a direction tangent to a circle defined by the gas outlets in the nozzle, such both an outward radial component and a tangent component is imparted to the momentum of the gas exiting the gas outlets (not illustrated). As previously described herein, the angle A of the gas outlet passages 25 may be 0°, such that only a tangent component is imparted to the momentum of the gas emitted from the gas outlets. I another alternative embodiment, the gas outlet passages may be formed along paths that approximate or equal a portion of a helix, to impart a swirling motion to the gas. The helical paths may expand to direct the swirling gas outward into contact with the oxygen exiting the outer tube, converge to accelerate the angular velocity of the swirling gas exiting the nozzle, or neither converges nor expand (e.g. follow cylindrical paths).

In a third embodiment of this alternative aspect of the present disclosure in which both gases are swirled, in the case of a swirl collar 120 as illustrated in FIGS. 2-5 that has four helical vanes 121-124 and four helical channels 131-134, the central tube may supply gas to every other helical channel, for example to a first set of helical channels 131 and 133, and the outer tube may supply oxygen to the intervening helical channels, for example to a second set of helical channels 132 and 134. This may be achieved by blocking off the bottom ends of the first set of helical channels so that the outer tube only communicates with the second set of helical channels and by providing a set of holes or bores in the central tube (and the collar 120 if necessary) that communicate the interior of the central tube with the first set of helical channels. In such an embodiment, the nozzle 18 may not have any gas outlets or may include a single pilot gas outlet. In a variation of this third embodiment, the central tube may be disposed of and a manifold (not illustrated) may direct gas to the first set of helical channels and direct the oxygen to the second set of helical channels. As previously described herein, the number of helical vanes and helical changes may vary.

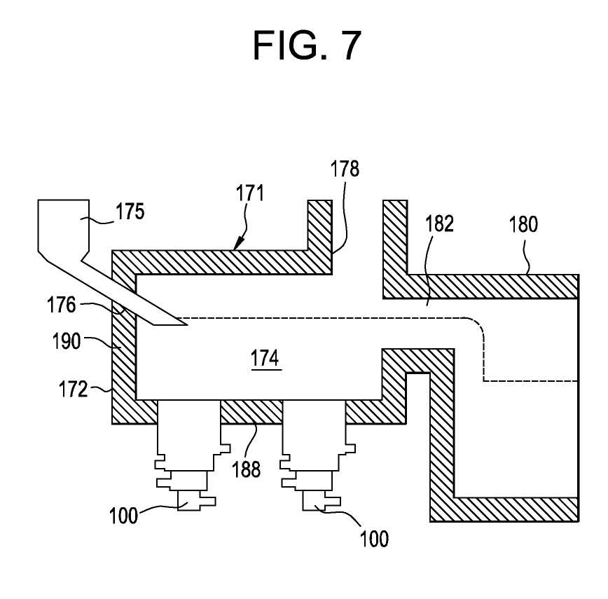

FIG. 7 shows a submerged combustion melting apparatus 171 including a melting chamber 172 containing a molten pool 174. The melting chamber 172 includes a port 176 for feeding batch material from a hopper 175 into the melting chamber 172. The batch material may be provided in liquefied form. The melting chamber 172 also includes a port 168 through which exhaust gases can escape the melting chamber 172. The melting apparatus 171 also includes a conditioning chamber 180 connected to the melting chamber 172 by a flow passage 182. Molten material from the molten pool 164 flows from the melting chamber 172 to the conditioning chamber 180 through the flow passage 182 and then exits the melting apparatus 171. Orifices 186 are formed in the wall of the melting chamber 162. The orifices 176 are shown in the bottom wall 188 of the melting chamber 172. In alternate arrangements, the orifices 176 may be provided in the side wall 190 of the melting chamber 172. The orifices 186 may be perpendicular or slanted relative to the wall of the melting chamber 172. Burner apparatus 100 are arranged in the orifices 186 to inject flames into the molten pool 174.

Swirling at least one of the gas and the oxygen exiting a SCM burner has the advantageous effects of lowering the vertical component of the momentum of the combustion gasses, which results in a reduced amount of glass being flung upwards into the melter, and enhanced mixing the oxygen and gas, which provides for more efficient combustion.

It will be apparent to those skilled in the art that various modifications and variations can be made without departing from the spirit or scope of the invention.

What is claimed is:

1. A burner for submerged combustion melting comprising:
a hollow central tube having a top end and a bottom end;
a first gas supply line in communication with an interior of the central tune for delivering a first gas through the central tube and out the top end of the central tube;
an hollow outer tube concentrically mounted around the central tube forming an annular space between the central tube and the outer tube, the outer tube having a bottom end and a top end adjacent to the top end of the central tube;
a second gas supply line in communication with the annular space for delivering a second gas through the outer tube and out an upper end of the outer tube for mixing and combusting with the first gas;
a swirl inducing member in the top end of one of the first tube and the annular space for causing a corresponding one of the first gas and the second gas to swirl as it exits the corresponding one of the first tube and the second tube.

2. A burner as in claim 1, further comprising a first said swirl inducing member in the top end of the central tune and a second said swirling member in the top end of the outer tube.

3. A burner as in claim 2, wherein the first and second swirl inducing members are each comprised of helical vanes.

4. A burner as in claim 1, wherein the swirl inducing member comprises helical vanes.

5. A burner as in claim 1, wherein the swirl inducing member is located in the top end of the outer tube, and an inner peripheral surface of the outer tube converges approaching the top end of the outer tube to accelerate the swirl of the second gas as it exits the outer tube.

6. A burner as in claim 1, further comprising:
a nozzle on a top end of the central tube, a plurality of gas outlet passing through the nozzle in communication with an interior of the central tube; and
wherein the at least one swirling member comprises helical vanes in the top end of the annular space.

7. A burner as in claim 6, wherein the plurality of the at least one glass outlets are slanted outwardly at an angle in a range from 25° to 65° relative to a longitudinal axis of the central tube.

8. A burner as in claim 6, wherein the plurality of the at least one glass outlets are arranged in a circle around the longitudinal axis of the central tube and are vertically inclined in a direction tangent to the circle.

9. A burner as in claim 6, wherein the plurality of the at least one glass outlets are arranged in a circle around the longitudinal axis of the central tube and are each formed as a segment of a helix.

10. A burner as in claim 4, wherein the helical vanes extend outward from a collar mounted on the top end of the central tube.

11. A submerged combustion melting apparatus, comprising:
a melting chamber for containing a molten pool, said melting chamber having an orifice formed in a wall thereof; and
a burner positioned at the orifice to inject a flame into the melting chamber, the burner comprising:
a hollow central tube having a top end and a bottom end;
a first gas supply line in communication with an interior of the central tune for delivering a first gas through the central tube and out the top end of the central tube;
an hollow outer tube concentrically mounted around the central tube forming an annular space between the central tube and the outer tube, the outer tube having a bottom end and a top end adjacent to the top end of the central tube;
a second gas supply line in communication with the annular space for delivering a second gas through the outer tube and out an upper end of the outer tube for mixing and combusting with the first gas;
a swirl inducing member in the top end of one of the first tube and the annular space for causing a corresponding one of the first gas and the second gas to swirl as it exits the corresponding one of the first tube and the second tube.

12. A melting apparatus as in claim 11, comprising a first said swirl inducing member in the top end of the central tune and a second said swirling member in the top end of the outer tube.

13. A melting apparatus as in claim 12, wherein the first and second swirl inducing members are each comprised of helical vanes.

14. A melting apparatus as in claim 11, wherein the swirl inducing member comprises helical vanes.

15. A melting apparatus as in claim 11, further comprising:
a nozzle on a top end of the central tube, a plurality of gas outlet passing through the nozzle in communication with an interior of the central tube; and
wherein the at least one swirling member comprises helical vanes in the top end of the annular space.

16. A burner as in claim 15, wherein the helical vanes extend outward from a collar mounted on the top end of the central tube.

17. A method of melting glass comprising the steps of:
emitting a first gas from a first nozzle up into a melting tank,
emitting a second gas from a second annular nozzle that surrounds the first nozzle;
swirling the gas being emitted from at least one of the first nozzle and the second nozzle.

18. The method of claim 17, further comprising swirling both the first gas being emitted from the first nozzle and swirling the second gas being emitted form the second nozzle.
